(19) United States
(12) Patent Application Publication
(10) Pub. No.: US 2022/0089149 A1
(43) Pub. Date: Mar. 24, 2022

(54) TURN ASSIST DEVICE FOR VEHICLE, TURN ASSIST METHOD FOR VEHICLE, AND COMPUTER-READABLE MEDIUM STORING TURN ASSIST PROGRAM

(71) Applicants: ADVICS CO., LTD., Kariya-shi (JP); DENSO CORPORATION, Kariya-city (JP); AISIN CORPORATION, Kariya-shi (JP); JTEKT CORPORATION, Kariya-shi (JP); J-QuAD DYNAMICS INC., Tokyo (JP)

(72) Inventor: Yosuke OMORI, Kariya-shi (JP)

(73) Assignees: ADVICS CO., LTD., Kariya-shi (JP); DENSO CORPORATION, Kariya-city (JP); AISIN CORPORATION, Kariya-shi (JP); JTEKT CORPORATION, Kariya-shi (JP); J-QuAD DYNAMICS INC., Tokyo (JP)

(21) Appl. No.: 17/465,107

(22) Filed: Sep. 2, 2021

(30) Foreign Application Priority Data
Sep. 23, 2020 (JP) 2020-158528

(51) Int. Cl. B60W 30/09; B60W 30/095; B60W 40/04; B60W 40/109; B60W 10/20; B60W 10/18

(52) U.S. Cl. CPC B60W 30/09; B60W 30/0956; B60W 40/04; B60W 40/109; B60W 2520/14; B60W 10/18; B60W 2510/202; B60W 2510/205; B60W 2520/125; B60W 10/20

(57) ABSTRACT

A turn assist device is configured to execute a turn assist process that assists turning of a vehicle in a case in which a steering operation of a steering wheel is in progress in a situation in which collision prediction time is shorter than or equal to determination prediction time. The turn assist process includes: an in-phase process that outputs a command for steering a rear wheel in the same direction as a steering direction of a front wheel, and a counter-phase process that outputs a command for steering the rear wheel in a direction opposite to the steering direction of the front wheel when a difference between an actual value of the lateral acceleration of the vehicle and a lateral acceleration target value exceeds a difference determination value during execution of the in-phase process.

### BACKGROUND

### 1. Field

The present disclosure relates to a turn assist device for a vehicle, a turn assist method for a vehicle, and a computer-readable medium storing a turn assist program.

### 2. Description of Related Art

Japanese Laid-Open Patent Publication No. 2017-226340 discloses an example of a turn assist device that assists turning of a vehicle when a driver performs a steering operation under a situation in which an obstacle exists in the path of the vehicle. This turn assist device performs an in-phase control, which steers the rear wheels in the same direction as the front wheels, which are steered in accordance with a steering operation by the driver.

When avoiding a collision between a vehicle and an obstacle by turning of the vehicle through a steering operation by the driver, it is preferable to increase the movement amount in the lateral direction of the vehicle.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a turn assist device for a vehicle is provided. The vehicle includes wheels including a front wheel and a rear wheel, a rear wheel steering device that adjusts a steered angle of the rear wheel, and a steering wheel. The front wheel is configured to be steered in accordance with a steering operation of the steering wheel. The turn assist device includes processing circuitry configured to execute a time obtaining process that obtains collision prediction time. The collision prediction time is a predicted value of an amount of time before the vehicle collides with an obstacle in a case in which the vehicle is approaching the obstacle. The processing circuitry is also configured to execute a target value obtaining process that obtains a lateral acceleration target value based on a vehicle speed and a steering angle of the steering wheel. The lateral acceleration target value is a target value of a lateral acceleration of the vehicle. The processing circuitry is further configured to execute a turn assist process in a case in which the steering operation of the steering wheel is in progress in a situation in which the collision prediction time is shorter than or equal to determination prediction time. The turn assist process assists turning of the vehicle by outputting a command for steering the rear wheel to the rear wheel steering device. The turn assist process includes an in-phase process and a counter-phase process. The in-phase process outputs, to the rear wheel steering device, a command for steering the rear wheel in a same direction as a steering direction of the front wheel. The counter-phase process outputs, to the rear wheel steering device, a command for steering the rear wheel in a direction opposite to the steering direction of the front wheel when a difference between an actual value of the lateral acceleration of the vehicle and the lateral acceleration target value exceeds a difference determination value during execution of the in-phase process.

As compared to a case in which steering of the rear wheel is controlled through the counter-phase process, the movement amount in the lateral direction of the vehicle can be increased in a case in which steering of the rear wheel is controlled through the in-phase process at an initial stage of the control, in which the movement amount in the longitudinal direction of the vehicle from the starting point in time of the turn assist process is relatively small. However, when the movement amount in the longitudinal direction of the vehicle is relatively large, the movement amount in the lateral direction of the vehicle in a case in which steering of the rear wheel is controlled through the counter-phase process exceeds the movement amount in the lateral direction of the vehicle in a case in which steering of the rear wheel is controlled through the in-phase process.

With the above-described configuration, when the collision prediction time is shorter than or equal to the determination prediction time in a situation in which an obstacle exists forward of the vehicle, the turn assist process is executed while an steering operation is in progress. At the start of the turn assist process, the in-phase process steers the rear wheel in the same direction as the steering direction of the front wheel. When the in-phase process is adjusting the steering action of the rear wheel, the difference between the actual value of the lateral acceleration of the vehicle and the target value of the lateral acceleration gradually increases as the movement amount in the longitudinal direction of the vehicle increases. When the difference exceeds the difference determination value, the process is switched from the in-phase process to the counter-phase process. The rear wheel then starts being steered in the direction opposite to the steering direction of the front wheel. That is, the above-described configuration executes the in-phase process at an initial stage of the turn assist process and executes the counter-phase process thereafter. This increases the movement amount in the lateral direction of the vehicle as compared to a case in which the in-phase process continues being executed.

In another aspect, a non-transitory computer readable medium storing a turn assist program executed by a controller for a vehicle is provided. The vehicle includes wheels including a front wheel and a rear wheel, a rear wheel steering device that adjusts a steered angle of the rear wheel, and a steering wheel. The front wheel is configured to be steered in accordance with a steering operation of the steering wheel. The turn assist program is configured to cause the controller to execute: a time obtaining process that obtains collision prediction time, the collision prediction time being a predicted value of an amount of time before the vehicle collides with an obstacle in a case in which the vehicle is approaching the obstacle; a turn assist process in a case in which the steering operation of the steering wheel is in progress in a situation in which the collision prediction time is shorter than or equal to determination prediction time, the turn assist process assisting turning of the vehicle by outputting a command for steering the rear wheel to the rear wheel steering device; and a target value obtaining process that obtains a lateral acceleration target value based on a vehicle speed and a steering angle of the steering wheel, the lateral acceleration target value being a target value of a lateral acceleration of the vehicle. The turn assist process includes an in-phase process and a counter-phase process. The in-phase process outputs, to the rear wheel steering device, a command for steering the rear wheel in a same direction as a steering direction of the front wheel. The counter-phase process outputs, to the rear wheel steering device, a command for steering the rear wheel in a direction opposite to the steering direction of the front wheel when a difference between an actual value of the lateral acceleration of the vehicle and the lateral acceleration target value exceeds a difference determination value during execution of the in-phase process.

In a further aspect, a turn assist method for a vehicle is provided. The vehicle includes wheels including a front wheel and a rear wheel, a rear wheel steering device that adjusts a steered angle of the rear wheel, and a steering wheel. The front wheel is configured to be steered in accordance with a steering operation of the steering wheel. The turn assist method includes: obtaining collision prediction time, the collision prediction time being a predicted value of an amount of time before the vehicle collides with an obstacle in a case in which the vehicle is approaching the obstacle; obtaining a lateral acceleration target value based on a vehicle speed and a steering angle of the steering wheel, the lateral acceleration target value being a target value of a lateral acceleration of the vehicle; and executing a turn assist process in a case in which the steering operation of the steering wheel is in progress in a situation in which the collision prediction time is shorter than or equal to determination prediction time, the turn assist process assisting turning of the vehicle by outputting a command for steering the rear wheel to the rear wheel steering device. The turn assist process includes an in-phase process and a counter-phase process. The in-phase process outputs, to the rear wheel steering device, a command for steering the rear wheel in a same direction as a steering direction of the front wheel. The counter-phase process outputs, to the rear wheel steering device, a command for steering the rear wheel in a direction opposite to the steering direction of the front wheel when a difference between an actual value of the lateral acceleration of the vehicle and the lateral acceleration target value exceeds a difference determination value during execution of the in-phase process.

Other features and aspects will be apparent from the following detailed description, the drawings, and the claims.

### BRIEF DESCRIPTION OF THE DRAWINGS

FIG. 1 is a diagram showing a function configuration of an integrated controller, which is a vehicle turn assist device according to one embodiment, and a schematic configuration of a vehicle equipped with the integrated controller.

FIG. 2 is a flowchart showing a procedure of processes executed by the integrated controller of FIG. 1.

FIG. 3 is a schematic diagram showing a situation in which an obstacle exists in the path of a vehicle.

FIG. 4 is a map for calculating determination prediction time based on a collision avoidance lateral movement amount.

FIG. 5 is a map for calculating a steering torque determination value based on a vehicle speed.

FIG. 6 is a map for calculating a steering speed determination value based on a vehicle speed.

FIG. 7 is a graph showing a relationship between a movement amount in a longitudinal direction and a movement amount in a lateral direction of the vehicle when the vehicle turns.

FIG. 8 is a timing diagram showing changes in a front wheel steered angle, a lateral acceleration, a rear wheel steered angle, and a braking/driving force when the vehicle is caused to turn through a steering operation by the driver.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

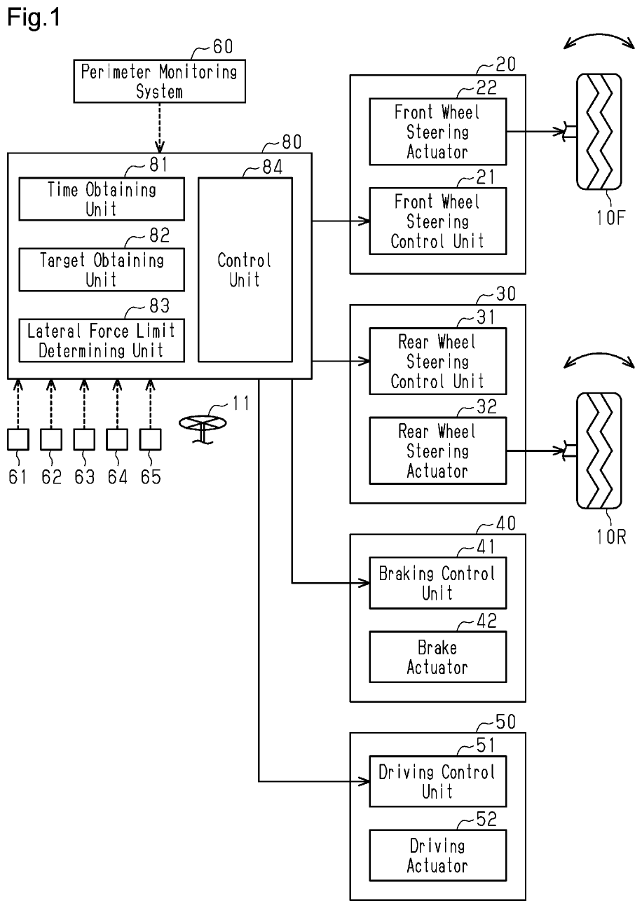

A vehicle turn assist device according to one embodiment will now be described with reference to FIGS. 1 to 8.

FIG. 1 shows a vehicle equipped with an integrated controller 80, which is one example of the turn assist device. The vehicle includes wheels 10F and 10R, a front wheel steering device 20, and a rear wheel steering device 30. In the present embodiment, the vehicle includes front wheels 10F, which include a right front wheel and a left front wheel, and rear wheels 10R, which include a right rear wheel and a left rear wheel.

The front wheel steering device 20 includes a front wheel steering control unit 21 and a front wheel steering actuator 22. When the driver is manipulating a steering wheel 11, that is, when the driver is performing a steering operation, the front wheel steering control unit 21 controls operation of the front wheel steering actuator 22 based on the steering operation. Accordingly, the steered angle of the front wheels 10F is adjusted in accordance with the steering operation by the driver.

The rear wheel steering device 30 includes a rear wheel steering control unit 31 and a rear wheel steering actuator 32. The rear wheel steering control unit 31 controls operations of the rear wheel steering actuator 32 so as to adjust the steered angle of the rear wheels 10R.

The front wheel steering control unit 21 and the rear wheel steering control unit 31 may have any one of the following configurations (a) to (c).

(a) Circuitry including one or more processors that execute various processes according to computer programs. The processor includes a CPU and a memory such as RAM and ROM. The memory stores program codes or instructions configured to cause the CPU to execute processes. The memory, which is a computer-readable medium, includes any type of media that are accessible by general-purpose computers and dedicated computers.

(b) Circuitry including one or more dedicated hardware circuits that execute various processes. The dedicated hardware circuits include, for example, an application specific integrated circuit (ASIC) and a field programmable gate array (FPGA).

(c) Circuitry including a processor that executes part of various processes according to programs and a dedicated hardware circuit that executes the remaining processes.

The vehicle further includes a braking device 40 and a driving device 50.

The braking device 40 includes a braking control unit 41 and a brake actuator 42. The braking control unit 41 controls operations of the brake actuator 42 so as to adjust braking force applied to the respective wheels 10F, 10R.

The driving device 50 includes a driving control unit 51 and a driving actuator 52. The driving actuator 52 includes drive sources of the vehicle such as an engine and/or an electric motor, and a driving force transmitting device, which transmits driving force output from the drive sources to wheels. For example, if the vehicle is a front-wheel drive vehicle, the driving force output from the drive source is distributed to the front wheels 10F via the driving force transmitting device. Operation of the driving actuator 52 is controlled by the driving control unit 51.

The braking control unit 41 and the driving control unit 51 may have any one of the above-described configurations (a) to (c).

The vehicle includes a perimeter monitoring system 60, which monitors the perimeters of the vehicle. The perimeter monitoring system 60 includes image pickup devices such as cameras and radars. The perimeter monitoring system 60 monitors the number and the positions of other vehicles located around the vehicle and whether there is an obstacle in the path of the vehicle. Obstacles in this description refer to objects of such sizes that collision with the vehicle needs to be avoided. Obstacles may include other vehicles, guardrails, and pedestrians.

The vehicle includes various types of sensors. The sensors may include a vehicle speed sensor 61, a longitudinal acceleration sensor 62, a lateral acceleration sensor 63, a yaw rate sensor 64, and a steering angle sensor 65. The vehicle speed sensor 61 detects a vehicle speed Vxe, which is a moving speed in the longitudinal direction of the vehicle, and outputs a detection signal corresponding to the detection result to the integrated controller 80. The longitudinal acceleration sensor 62 detects a longitudinal acceleration Axe, which is an acceleration in the longitudinal direction of the vehicle, and outputs a detection signal corresponding to the detection result to the integrated controller 80. The lateral acceleration sensor 63 detects a lateral acceleration Aye, which is an acceleration in the lateral direction of the vehicle, and outputs a detection signal corresponding to the detection result to the integrated controller 80. The yaw rate sensor 64 detects a yaw rate γ of the vehicle, and outputs a detection signal corresponding to the detection result to the integrated controller 80. The steering angle sensor 65 detects a steering angle STr, which is a rotation angle of the steering wheel 11, and outputs a detection signal corresponding to the detection result to the integrated controller 80. In the present embodiment, the steering angle sensor 65 detects, as the steering angle STr, a rotation angle of the steering wheel 11 with reference to a predetermined position of the steering wheel 11. For example, the predetermined position is set to the position of the steering wheel 11 when the vehicle is traveling in a straight line.

Based on information obtained by the perimeter monitoring system 60 and the detection signals from the sensors 61 to 65, the integrated controller 80 outputs various commands to the front wheel steering control unit 21, the rear wheel steering control unit 31, the braking control unit 41, and the driving control unit 51.

The integrated controller 80, which is processing circuitry, may have any one of the above-described configurations (a) to (c). In the present embodiment, the integrated controller 80 includes a CPU, ROM, and a memory device. The ROM stores control programs executed by the CPU. The memory device stores values calculated when the CPU executes the control programs. That is, the ROM stores a turning control program, which is needed in control for avoiding collision between the vehicle and an obstacle. Thus, the integrated controller 80 corresponds to a controller that executes the turning control program.

In the present embodiment, the integrated controller 80 includes, as functional units, a time obtaining unit 81, a target obtaining unit 82, a lateral force limit determining unit 83, and a control unit 84.

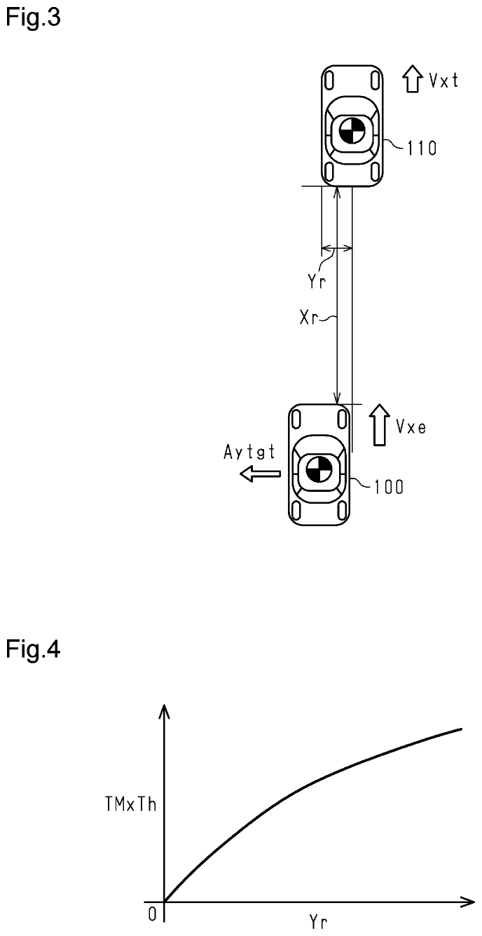

An example shown in FIG. 3 assumes that a vehicle 100 is approaching an obstacle 110, which is located forward of the vehicle 100. The time obtaining unit 81 obtains collision prediction time TMx, which is a predicted value of an amount of time before the vehicle 100 collides with the obstacle 110. A method for obtaining the collision prediction time TMx will be described later.

The target obtaining unit 82 obtains a lateral acceleration target value Aytgt, which is a target value of the lateral acceleration of the vehicle, based on the vehicle speed Vxe and the steering angle STr. A method for obtaining the lateral acceleration target value Aytgt will be described later.

The lateral force limit determining unit 83 determines whether the wheels 10F, 10R include a wheel receiving a lateral force greater than or equal to a limit value. The limit value refers to a value of lateral force acting on a wheel that is determined to cause a sideslip of the wheel during turning of the vehicle. The specific contents of this determination will be discussed later.

With the control unit 84 performs a turn assist control, which assists turning of the vehicle 100, when a steering operation is in progress in a situation in which the collision prediction time TMx is shorter than or equal to a determination prediction time TMxTh. The specific contents of the turn assist control will be discussed later.

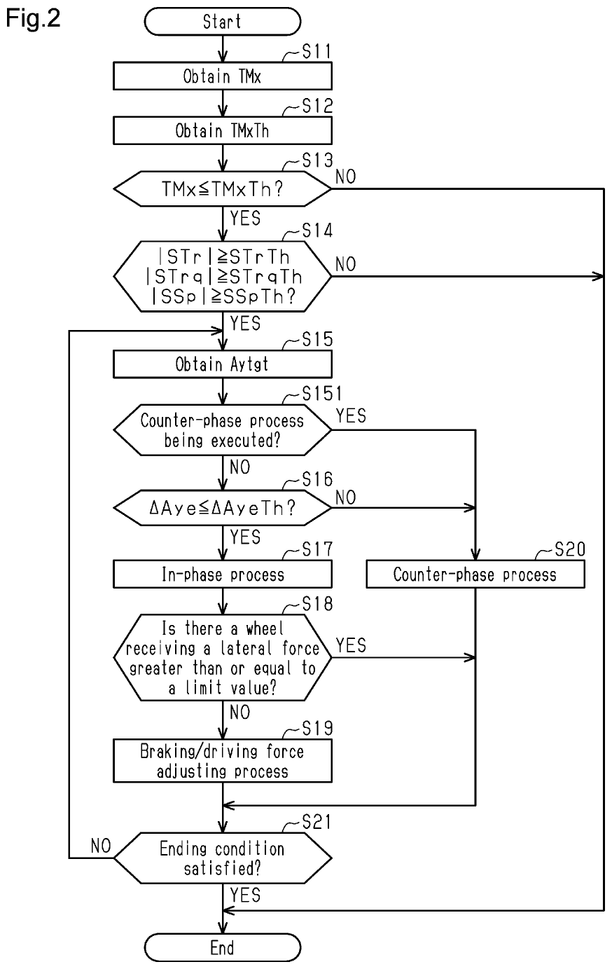

Next, with reference to FIG. 2, a series of processes executed by the integrated controller 80 according to the present embodiment will be described. The series of processes is executed when the obstacle 110 exists in the path of the vehicle 100. When the obstacle 110 exists in the path of the moving vehicle 100, the integrated controller 80 repeatedly executes the series of processes.

First, in step S11, the time obtaining unit 81 of the integrated controller 80 obtains the collision prediction time TMx.

One example of the process for obtaining the collision prediction time TMx will now be described. A longitudinal travel distance Xr shown in FIG. 3 is the length in the longitudinal direction of the space from the vehicle 100 to the obstacle 110. The time obtaining unit 81 calculates an approach speed Vxr of the vehicle 100 toward the obstacle 110. In a case in which the obstacle 110 is a leading vehicle as shown in FIG. 3, the time obtaining unit 81 calculates, as the approach speed Vxr, a value obtained by subtracting the vehicle speed Vxt of the leading vehicle (the obstacle 110) from the vehicle speed Vxe of the vehicle 100. Thus, a positive value is obtained as the approach speed Vxr in a case in which the vehicle 100 is approaching the obstacle 110. Then, the time obtaining unit 81 divides the longitudinal travel distance Xr by the approach speed Vxr to obtain the collision prediction time TMx. The longitudinal travel distance Xr and the vehicle speed Vxt of the vehicle speed Vxt of the leading vehicle (the obstacle 110) are obtained based on monitoring results of the perimeter monitoring system 60.

Referring to FIG. 2, when the obtainment of the collision prediction time TMx is completed, the integrated controller 80 advances the process to the next step S12. In step S12, the time obtaining unit 81 obtains the determination prediction time TMxTh. For example, the time obtaining unit 81 obtains the determination prediction time TMxTh using a map shown in FIG. 4.

The process for obtaining the determination prediction time TMxTh using the map shown in FIG. 4 will now be described. The map shown in FIG. 4 is a map for calculating the determination prediction time TMxTh based on a collision avoidance lateral movement amount Yr. The collision avoidance lateral movement amount Yr is a movement amount in the lateral direction of the vehicle 100 required to avoid a collision between the vehicle 100 and the obstacle 110 through turning of the vehicle 100 as shown in FIG. 3. The collision avoidance lateral movement amount Yr is obtained based on monitoring results of the perimeter monitoring system 60. As shown in FIG. 4, the determination prediction time TMxTh is set to a greater value as the collision avoidance lateral movement amount Yr increases. This is because it is preferable to start a turning maneuver of the vehicle 100 for avoiding a collision between the vehicle 100 and the obstacle 110 at an earlier stage as the collision avoidance lateral movement amount Yr increases.

Referring to FIG. 2, when the obtainment of the determination prediction time TMxTh is completed, the integrated controller 80 advances the process to step S13. In step S13, the control unit 84 of the integrated controller 80 determines whether the collision prediction time TMx is shorter than or equal to the determination prediction time TMxTh. When the collision prediction time TMx is shorter than or equal to the determination prediction time TMxTh, the vehicle 100 is likely to collide with the obstacle 110 unless the vehicle 100 is caused to turn. Thus, when the collision prediction time TMx is shorter than or equal to the determination prediction time TMxTh (S13: YES), the integrated controller 80 advances the process to the next step S14.

When the collision prediction time TMx is longer than the determination prediction time TMxTh, it is considered that the turn assist control does not need to be performed in order to avoid a collision between the vehicle 100 and the obstacle 110. Therefore, when the collision prediction time TMx is longer than the determination prediction time TMxTh (S13: NO), the integrated controller 80 temporarily suspends the series of processes. That is, the turn assist control is not performed even if the driver is performing a steering operation.

In step S14, the control unit 84 determines whether a steering operation is being performed by the driver. In the present embodiment, the control unit 84 determines that a steering operation is in progress if all the conditions (A1), (A2), and (A3) shown below are satisfied. In contrast, the control unit 84 determines that a steering operation is not in progress if any of the conditions (A1), (A2), and (A3) is not satisfied.

(A1) The steering angle STr is greater than or equal to a steering angle determination value STrTh.

(A2) A steering torque STrq, which is applied to the steering wheel 11 by the driver, is greater than or equal to a steering torque determination value STrqTh.

(A3) A steering speed SSp, which is a changing speed of the steering angle STr, is greater than or equal to a steering speed determination value SSpTh.

The steering angle determination value STrTh is set to such a value that whether the driver intends to cause the vehicle 100 to turn can be determined based on the steering angle STr. The steering torque determination value STrqTh is set to such a value that whether the driver intends to cause the vehicle 100 to turn can be determined based on the steering torque STrq. The steering speed determination value SSpTh is set to such a value that whether the driver intends to cause the vehicle 100 to turn can be determined based on the steering speed SSp.

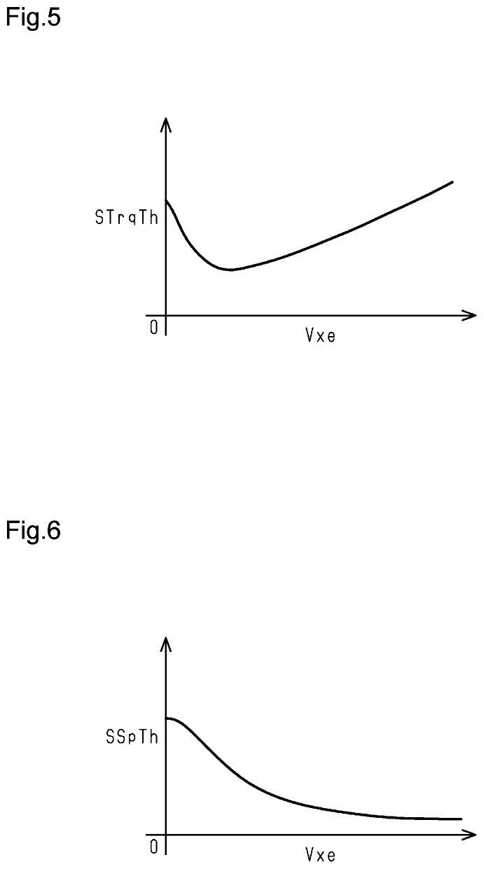

FIG. 5 shows one example of a map for setting the steering torque determination value STrqTh based on the vehicle speed Vxe. According to FIG. 5, the steering torque determination value STrqTh is set to a smaller value as the vehicle speed Vxe increases in a low vehicle speed range. This is because when the vehicle speed Vxe is relatively low, the steering wheel 11 cannot be rotated unless the steering torque STrq is increased. When the vehicle speed Vxe reaches a certain level, the steering torque determination value STrqTh is set to a greater value as the vehicle speed Vxe increases thereafter. This is because in a state in which the vehicle speed Vxe is high to a certain extent, the self-aligning torque increases as the vehicle speed Vxe increases. The steering torque STrq needs to be increased by a larger degree to increase the steering angle STr in a case in which the self-aligning torque is relatively high than in a case in which the self-aligning torque is relatively low.

FIG. 6 shows one example of a map for setting the steering speed determination value SSpTh based on the vehicle speed Vxe. As shown in FIG. 6, the steering speed determination value SSpTh is set to a greater value as the vehicle speed Vxe decreases. This is because in order to increase the amount of turning of the vehicle 100, the steering angle STr needs to be increased at an earlier stage as the vehicle speed Vxe decreases.

Referring to FIG. 2, when at least one of the conditions (A1), (A2), and (A3) is not satisfied in step S14 (NO), the control unit 84 determines that the steering operation is not in progress. Thus, the integrated controller 80 temporarily suspends the series of processes. In contrast, all the conditions (A1), (A2), and (A3) are satisfied (S14: YES), the control unit 84 determines that the steering operation is in progress. The integrated controller 80 thus advances the process to the next step S15.

In step S15, the target obtaining unit 82 of the integrated controller 80 obtains the lateral acceleration target value Aytgt. For example, target obtaining unit 82 calculates the lateral acceleration target value Aytgt using the following expression 1. In the expression 1, the symbol Gin represents a gain that is set from the specifications of the vehicle 100, and is greater than 1. The symbol L represents the wheelbase of the vehicle 100. The symbol L represents the gear ratio of the steering wheel 11. The symbol SF represents the stability factor of the vehicle 100.

$$Aytgt = Gin \cdot \frac{{Vxe}^{2} \cdot STr}{L \cdot N \cdot ( SF \cdot {Vxe}^{2} - 1 )} \qquad Expression 1$$

When the obtainment of the lateral acceleration target value Aytgt is completed, the integrated controller 80 starts the turn assist control. That is, in step S151, the control unit 84 of the integrated controller 80 determines whether a counter-phase process, which will be described later, is being executed. If the counter-phase process is being executed (S151: YES), the integrated controller 80 advances the process to step S20. If the counter-phase process is not being executed (S151: NO), the integrated controller 80 advances the process to step S16.

In step S16, the control unit 84 determines whether a lateral acceleration difference ΔAye is less than or equal to a difference determination value ΔAyeTh. The lateral acceleration difference ΔAye is the difference between the lateral acceleration Aye, which is a detection value of the lateral acceleration, and the lateral acceleration target value Aytgt. In the present embodiment, the lateral acceleration Aye corresponds to the actual value of a lateral acceleration. The difference determination value ΔAyeTh is used as a criterion for determining whether the lateral acceleration difference ΔAye is large or not. As will be described in detail below, in a case in which steering of the rear wheels 10R is being controlled through the in-phase process, the lateral acceleration difference ΔAye is not increased significantly while the movement amount in the longitudinal direction of the vehicle 100 is still relatively small from the starting point in time of the turn assist control, as at an initial stage. However, when the movement amount in the longitudinal direction of the vehicle 100 from the starting point in time of the turn assist control increases, the lateral acceleration difference ΔAye gradually increases. Thus, at an initial stage of the turn assist control, the lateral acceleration difference ΔAye is less than or equal to the difference determination value ΔAyeTh. Then, the lateral acceleration difference ΔAye gradually increases and eventually exceeds the difference determination value ΔAyeTh.

When the lateral acceleration difference ΔAye is less than or equal to the difference determination value ΔAyeTh (S16: YES), the integrated controller 80 advances the process to step S17. In step S17, the control unit 84 executes the in-phase process, which outputs, to the rear wheel steering control unit 31 of the rear wheel steering device 30, a command for steering the rear wheels 10R in the same direction as the steering direction of the front wheels 10F. The specific contents of the in-phase process will be discussed later.

When receiving this command from the integrated controller 80, the rear wheel steering control unit 31 controls the rear wheel steering actuator 32, so as to steer the rear wheels 10R in the same direction as the steering direction of the front wheels 10F.

After outputting this command to the rear wheel steering control unit 31, the integrated controller 80 advances the process to step S18. In step S18, the lateral force limit determining unit 83 of the integrated controller 80 determines whether the wheels 10F, 10R include a wheel receiving a lateral force greater than or equal to the limit value. For example, the lateral force limit determining unit 83 determines that the lateral force applied to the wheel is greater than or equal to the limit value when the following expression 2 is satisfied. In the expression 2, the symbol μ represents the friction coefficient of the road surface on which the vehicle 100 is traveling. The symbol W represents a vertical load applied to the wheel. The symbol Fy represents the lateral force applied to the wheel. The vertical load W refers to a load that is applied to the wheel by the vehicle body in the direction vertical to the road surface. For example, the vertical load acting on each of the wheels 10F and 10R is calculated based on the weight of the vehicle 100, the longitudinal acceleration Axe, and the lateral acceleration Aye.

(μ·W)²−Fy²<0 Expression 2

Also, the lateral force Fy acting on the wheel is calculated based on the following expressions 3 and 4. The expression 3 is used to calculate the lateral force Fyf acting on each of the front wheels 10F. The expression 4 is used to calculate the lateral force Fyr acting on each of the rear wheels 10R. In the expressions 3 and 4, the symbol Kf represents the cornering power of the front wheels 10F, and Kr represents the cornering power of the rear wheels 10R. The symbol δr represents the vehicle slip angle at the center of gravity of the vehicle 100. The symbol Lf represents the distance between the center of gravity of the vehicle 100 and the front axle, and the symbol Lr represents the distance between the center of gravity of the vehicle 100 and the rear axle. The sum of Lf and Lr is equal to the wheelbase L of the vehicle 100. The symbol δf represents the steered angle of the front wheels 10F, and the symbol δr represents the steered angle of the rear wheels 10R. The steered angle δf of the front wheels 10F will be sometimes referred to as the front wheel steered angle δf, and the steered angle δr of the rear wheels 10R will be sometimes referred to as the rear wheel steered angle δr.

$$\begin{matrix}Fyf = - Kf \cdot ( β + \frac{Lf}{Vxe} \cdot γ - δ f ) & Expression 3 \\ Fyr = - Kr \cdot ( β - \frac{Lr}{Vxe} \cdot γ - δ r ) & Expression 4\end{matrix}$$

When the square of the lateral force Fy is greater than the square of the product of the friction coefficient μ of the road surface and the vertical load W, the wheel is likely to slide sideways. When the wheel is likely to slide sideways, increase in the braking force or the driving force applied to the wheel is not favorable to ensure stability of the vehicle behavior. In this regard, the lateral force limit determining unit 83 determines whether the wheels 10F, 10R include a wheel that satisfies the expression 2.

When determining that the wheels 10F, 10R include a wheel receiving a lateral force greater than or equal to the limit value (S18: YES), the integrated controller 80 advances the process to step S21. In this case, the control unit 84 does not execute a braking/driving force adjusting process, which will be discussed below. On the other hand, when determining that the wheels 10F, 10R do not include a wheel receiving a lateral force greater than or equal to the limit value (S18: NO), the integrated controller 80 advances the process to step S19.

In step S19, the control unit 84 executes the braking/driving force adjusting process. In the braking/driving force adjusting process according to the present embodiment, the control unit 84 outputs, to the braking control unit 41 of the braking device 40, a command for causing the braking force applied to the front wheel 10F located inside during turning to be greater than the braking force applied to the front wheel 10F located outside during turning, and a command for causing the braking force applied to the rear wheel 10R located inside during turning to be greater than the braking force applied to the rear wheel 10R located outside during turning. The specific contents of the braking/driving force adjusting process will be discussed later.

When receiving the commands, the braking control unit 41 controls the brake actuator 42 to cause the braking force applied to the front wheel 10F located inside during turning to be greater than the braking force applied to the front wheel 10F located outside during turning. Also, the braking control unit 41 controls the brake actuator 42 to cause the braking force applied to the rear wheel 10R located inside during turning to be greater than the braking force applied to the rear wheel 10R located outside during turning. This increases the yaw moment of the vehicle 100.

When the lateral acceleration difference ΔAye is greater than the difference determination value ΔAyeTh in step S16 (NO), the integrated controller 80 advances the process to step S20.

In step S20, the control unit 84 executes the counter-phase process, which outputs, to the rear wheel steering control unit 31 of the rear wheel steering device 30, a command for steering the rear wheels 10R in a direction opposite to the steering direction of the front wheels 10F. The specific contents of the counter-phase process will be discussed later.

When this command is delivered from the integrated controller 80 to the rear wheel steering control unit 31, the rear wheel steering control unit 31 controls the rear wheel steering actuator 32, so as to steer the rear wheels 10R in a direction opposite to the steered direction of the front wheels 10F.

After outputting this command to the rear wheel steering control unit 31, the integrated controller 80 advances the process to step S21.

In step S21, the integrated controller 80 determines whether an ending condition of the turn assist control is satisfied. For example, the integrated controller 80 determines that the ending condition is satisfied when detecting a decrease in the absolute value of the steering angle STr. In this case, if the steering angle STr has decreased and the difference between the value in the previous cycle and the latest value of the steering angle STr is greater than or equal to a determination value, the integrated controller 80 deems the absolute value of the steering angle STr to have decreased, and determines that the ending condition is satisfied.

When the ending condition is not satisfied (S21: NO), the integrated controller 80 advances the process to step S15. That is, the turn assist control is continued. When the ending condition is satisfied (S21: YES), the integrated controller 80 temporarily suspends the series of processes. That is, the turn assist control is ended.

In the present embodiment, step S15 corresponds to the target value obtaining process, which obtains the lateral acceleration target value Aytgt based on the vehicle speed Vxe and the steering angle STr. Also, steps S16, S17, S19, S20, and S21 correspond to the turn assist process. When the driver is performing a steering operation in a situation in which the collision prediction time TMx is shorter than or equal to the determination prediction time TMxTh, the turn assist process outputs a command for steering the rear wheels 10R to the rear wheel steering device 30, thereby assisting turning of the vehicle. Also, step S17 corresponds to the in-phase process, which outputs, to the rear wheel steering device 30, a command for steering the rear wheels 10R in the same direction as the steering direction of the front wheels 10F. Step S20 corresponds to the counter-phase process, which outputs, to the rear wheel steering device 30, a command for steering the rear wheels 10R in the direction opposite to the steering direction of the front wheels 10F.

Next, one example of the in-phase process will be described.

In the in-phase process, the control unit 84 calculates a rear wheel steered angle command value δrtgt, which is a command value of the steered angle of the rear wheels 10R. Then, the control unit 84 outputs, to the rear wheel steering control unit 31, the rear wheel steered angle command value δrtgt as a command for steering the rear wheels 10R in the same direction as the steering direction of the front wheels 10F.

The control unit 84 calculates the rear wheel steered angle command value δrtgt, for example, based on the following expressions 5 and 6. That is, the control unit 84 calculates the rear wheel steered angle command value δrtgt based on the vehicle speed Vxe, the yaw rate γ, the vehicle slip angle β, the front wheel steered angle δf, and the rear wheel steered angle δr.

$$\begin{matrix} Fytgt = Frf + Fyr & Expression 5 \\ δ rtgt = \frac{1}{Kr} \cdot \{ Fytgt + Kf ( β + \frac{Lf}{Vxe} \cdot γ - δ f ) \} + β - \frac{Lr}{Vxe} \cdot γ & Expression 6\end{matrix}$$

Next, one example of the counter-phase process will be described.

In the counter-phase process, the control unit 84 calculates the rear wheel steered angle command value δrtgt. Then, the control unit 84 outputs, to the rear wheel steering control unit 31, the rear wheel steered angle command value δrtgt as a command for steering the rear wheels 10R in the direction opposite to the steering direction of the front wheels 10F.

The control unit 84 calculates the rear wheel steered angle command value δrtgt, for example, based on the following expressions 7, 8, and 9. In the expressions 7 to 9, the symbol Gin1 represents a gain that is set from the specifications of the vehicle 100. The symbol γtgt represents a target value of the yaw rate γ of the vehicle 100 when the counter-phase process is executed. That is, the symbol γtgt is a yaw rate target value. The control unit 84 calculates the rear wheel steered angle command value δrtgt based on the vehicle speed Vxe, the vehicle slip angle β, the front wheel steered angle δf, and the rear wheel steered angle δr.

$$\begin{matrix} γ tgt = Gin 1 \cdot \frac{1}{1 + SF \cdot {Vxe}^{2}} \cdot \frac{Vxe}{L} \cdot δ f & Expression 7 \\ \frac{1}{Vxe} \cdot ( Kf \cdot {Lf}^{2} + Kr \cdot {Lr}^{2} ) \cdot γ tgt + ( Kf \cdot Lf - Kr \cdot Lr ) \cdot β = Kf \cdot Lf \cdot δ f - Kr \cdot Lr \cdot δ r & Expression 8 \\ δ rtgt = \frac{1}{Kr \cdot Lr} & Expression 9\end{matrix} \cdot \{ Kf \cdot Lf \cdot δ f - \frac{1}{Vxe} \cdot ( Kf \cdot {Lf}^{2} + Kr \cdot {Lr}^{2} ) \cdot γ tgt - ( Kf \cdot Lf - Kr \cdot Lr ) \cdot β \}$$

Next, one example of the braking/driving force adjusting process will be described.

The control unit 84 calculates braking force command values Fxf*, Fxr* in the braking/driving force adjusting process. The control unit 84 outputs, to the braking control unit 41, the braking force command values Fxr* corresponding to the respective front wheels 10F as command values that cause the braking force applied to the front wheel 10F located inside during turning to be greater than the braking force applied to the front wheel 10F located outside during turning. Also, the control unit 84 outputs, to the braking control unit 41, the braking force command values Fxr* corresponding to the respective rear wheels 10R as command values that cause the braking force applied to the rear wheel 10R located inside during turning to be greater than the braking force applied to the rear wheel 10R located outside during turning.

When the symbol * in the braking force command value Fxf* is replaced by the symbol 1, the braking force command value Fxfl is a command value of the braking force applied to the left front wheel 10F. When the symbol * in the braking force command value Fxf* is replaced by the symbol r, the braking force command value Fxfr is a command value of the braking force applied to the right front wheel 10F. When the symbol * in the braking force command value Fxr* is replaced by the symbol 1, the braking force command value Fxrl is a command value of the braking force applied to the left rear wheel 10R. When the symbol * in the braking force command value Fxr* is replaced by the symbol r, the braking force command value Fxrr is a command value of the braking force applied to the right rear wheel 10R.

The control unit 84 calculates the braking force command values Fxf*, Fxr* based on the following expressions 10, 11, 12, 13, and 14. In the expressions 10 to 14, the symbol γtgt represents a yaw rate target value used when the braking/driving force adjusting process is executed. The symbols Tdf* and Tdr* represent tread bases. That is, the symbol Tdfl represents a tread base for the left front wheel 10F, and the symbol Tdfr represents a tread base for the right front wheel 10F. The symbol Tdrl represents a tread base for the left rear wheel 10R, and the symbol Tdrr represents a tread base for the right rear wheel 10R.

$$\begin{matrix} γ tgt = Gin 1 \cdot \frac{1}{1 + SF \cdot {Vxe}^{2}} \cdot \frac{Vxe}{L} \cdot δ f & Expression 10 \\ Mzbrk = \frac{2 Kf \cdot Kr}{Kf + Kr} \cdot \{ ( 1 + SF \cdot {Vxe}^{2} ) \cdot \frac{{L}^{2}}{Vxe} \cdot γ tgt - L ( δ f - δ r ) \} & Expression 11 \\ \vert Fxf * lim \vert = \sqrt{{( μ \cdot W )}^{2} - Fyf {*}^{2}} & Expression 12 \\ \vert Fxr * lim \vert = \sqrt{{( μ \cdot W )}^{2} - Fyr {*}^{2}} & Expression 13 \\ α = \frac{Fxf * lim}{Fxf * lim + Fxr * lim} & Expression 14 \\ Fxf *= Min ( Fyf * lim , \frac{α}{Tdf *} \cdot Mzbrk ) & Expression 15 \\ Fxr *= Min ( Fyr * lim , \frac{α}{Tdr *} \cdot Mzbrk ) & Expression 16\end{matrix}$$

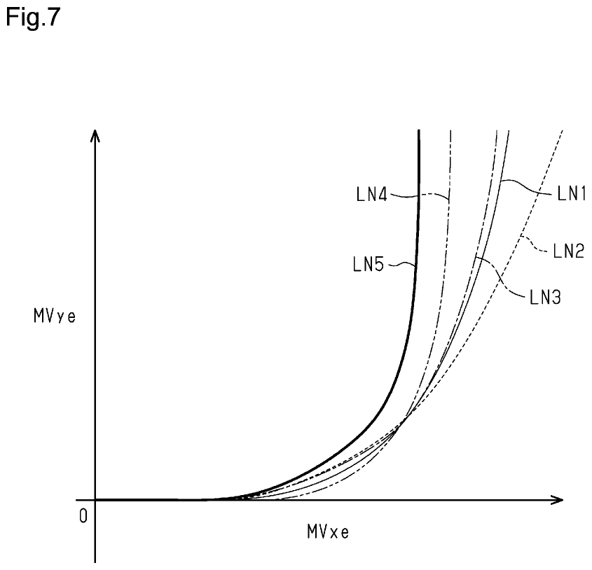

FIG. 7 shows a relationship between a longitudinal movement amount MVxe, which is a movement amount in the longitudinal direction of the vehicle 100, and a lateral movement amount MVye, which is a movement amount in the lateral direction of the vehicle 100, in a case in which the vehicle 100 turns through a steering operation by the driver. The thin solid line LN1 represents a relationship between the longitudinal movement amount MVxe and the lateral movement amount MVye in a first pattern, in which the above-described turn assist control is not performed. The broken line LN2 represents a relationship between the longitudinal movement amount MVxe and the lateral movement amount MVye in a second pattern, in which the in-phase process continues being executed. The long-dash short-dash line LN3 represents a relationship between the longitudinal movement amount MVxe and the lateral movement amount MVye in a third pattern, in which the in-phase process is first executed, and the process is then switched from the in-phase process to the counter-phase process. The long-dash double-short-dash line LN4 represents a relationship between the longitudinal movement amount MVxe and the lateral movement amount MVye in a fourth pattern, in which the counter-phase process continues being executed. The thick solid line LN5 represents a relationship between the longitudinal movement amount MVxe and the lateral movement amount MVye in a fifth pattern, in which the in-phase process is first executed, the process is then switched from the in-phase process to the counter-phase process, and the braking/driving force adjusting process is executed.

When the second pattern and the first pattern are compared with each other, the lateral movement amount MVye in the second pattern is larger than the lateral movement amount MVye in the first pattern when the longitudinal movement amount MVxe is relatively small. However, when the longitudinal movement amount MVxe increases to a certain extent, the lateral movement amount MVye in the first pattern becomes greater than the lateral movement amount MVye in the second pattern.

When the fourth pattern and the second pattern are compared with each other, the lateral movement amount MVye in the second pattern is larger than the lateral movement amount MVye in the fourth pattern when the longitudinal movement amount MVxe is relatively small. However, when the longitudinal movement amount MVxe increases to a certain extent, the lateral movement amount MVye in the fourth pattern becomes greater than the lateral movement amount MVye in the second pattern. Further, when the longitudinal movement amount MVxe increases to a certain extent, the lateral movement amount MVye in the fourth pattern is larger than the lateral movement amount MVye in the first pattern.

When the third and the first pattern are compared with each other, the in-phase process is executed at an earlier stage in the third pattern. Thus, when the longitudinal movement amount MVxe is relatively small, the lateral movement amount MVye in the third pattern is larger than the lateral movement amount MVye in the first pattern. In the third pattern, the counter-phase process is executed when the longitudinal movement amount MVxe is increased. As a result, even when the longitudinal movement amount MVxe increases, the lateral movement amount MVye in the third pattern is larger than the lateral movement amount MVye in the first pattern.

In the fifth pattern, the braking/driving force adjusting process is executed. Thus, the lateral movement amount MVye in the fifth pattern is larger than the lateral movement amount MVye of any other pattern regardless of the value of the longitudinal movement amount MVxe.

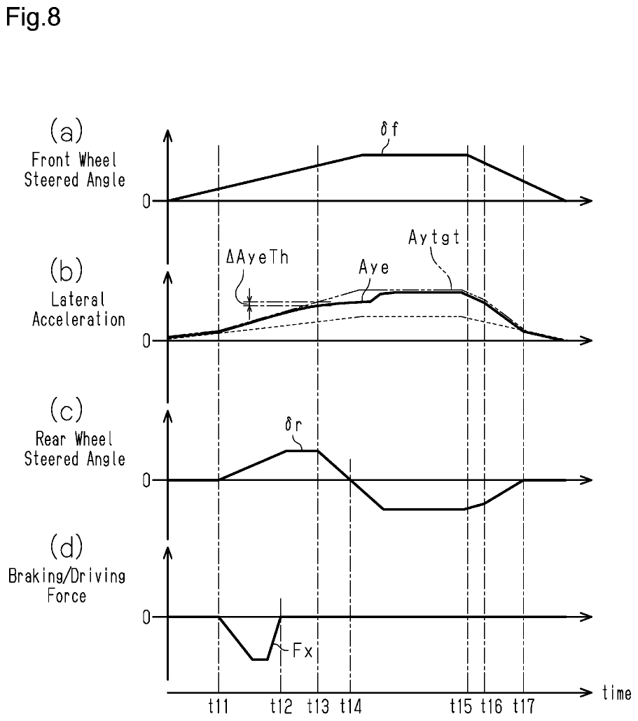

An operation of the present embodiment will be now described with reference to FIG. 8.

In a situation in which the collision prediction time TMx is shorter than or equal to the determination prediction time TMxTh with the vehicle 100 approaching the obstacle 110, the front wheel steered angle δf gradually increases if the driver starts an steering operation in order to avoid a collision between the obstacle 110 and the vehicle 100. Then, as shown in sections (a), (b), (c), and (d) of FIG. 8, the turn assist control is started if it is determined that the steering operation is in progress at a point in time t11. At an initial stage of the turn assist control, the lateral acceleration difference ΔAye, which is the difference between the lateral acceleration Aye and the lateral acceleration target value Aytgt is less than or equal to the difference determination value ΔAyeTh. Thus, from the point in time t11, the in-phase process is executed to adjust the rear wheel steered angle δr, which is the steered angle of the rear wheels 10R. That is, the rear wheels 10R are steered in the same direction as the steering direction of the front wheels 10F.

In the section (b) of FIG. 8, changes in the lateral acceleration Aye in the present embodiment are represented by the solid line, and changes in the lateral acceleration Aye in a case in which the turn assist control is not performed are represented by the broken line. Also, changes in the lateral acceleration target value Aytgt are represented by the long-dash double-short-dash line.

Also, in the present embodiment, the wheels 10F, 10R do not include a wheel receiving a lateral force greater than or equal to the limit value at the point in time at which the turn assist control is started. Accordingly, the braking/driving force adjusting process is also executed. This increases the yaw moment of the vehicle 100 as compared with a case in which the braking/driving force adjusting process is not executed. As a result, the lateral acceleration Aye of the vehicle 100 is increased, so that the lateral movement amount MVye of the vehicle 100 is increased.

At a point in time t13, at which the in-phase process is being executed, the lateral acceleration difference ΔAye is greater than the difference determination value ΔAyeTh. That is, the process is switched from the in-phase process to the counter-phase process since the lateral acceleration difference ΔAye has exceeded the difference determination value ΔAyeTh during the execution of the in-phase process. Then, the rear wheel steered angle δr is adjusted such that the steering direction of the rear wheels 10R is opposite to the steering direction of the front wheels 10F. At a point in time t14, which is after the counter-phase process is started, the steering direction of the rear wheels 10R becomes opposite to the steering direction of the front wheels 10F. Thus, after the point in time t14, the lateral acceleration difference ΔAye starts decreasing.

That is, the present embodiment performs the in-phase control at the initial stage of the turn assist control and performs the counter-phase control thereafter. Accordingly, the lateral movement amount MVye of the vehicle 100 is made greater than that in a case in which the in-phase process continues being executed, and that in a case in which the turn assist control is not performed. This allows the driver to avoid a collision between the obstacle 110 and the vehicle 100 by performing a steering operation without haste.

From a point in time t15, the steering angle STr starts decreasing. As a result, the front wheel steered angle δf decreases. Then, the ending condition of the turn assist control is satisfied at a point in time t16, so that the turn assist control is ended. That is, the counter-phase process is ended. Then, a decrease control of the rear wheel steered angle δr performed so that the rear wheel steered angle δr approaches 0. Subsequently, the rear wheel steered angle δr becomes 0 at a point in time t17, so that the decrease control is ended.

The present embodiment further has the following advantages.

(1) The present embodiment executes the braking/driving force adjusting process when the wheels 10F, 10R are determined to include no wheel receiving a lateral force greater than or equal to the limit value. In the example shown in FIG. 8, the wheels 10F, 10R are determined to include a wheel receiving a lateral force greater than or equal to the limit value at the point in time t12, so that the braking/driving force adjusting process is ended. That is, the braking force applied to the wheels 10F, 10R is adjusted within a range in which the lateral force acting on each of the wheels does not exceed the limit value. This increases the lateral movement amount MVye, while ensuring the stability of the behavior of the vehicle 100.

(2) The present embodiment determines that the driver is performing a steering operation when all the conditions (A1), (A2), and (A3) are satisfied. Thus, as compared to a case in which a steering operation is determined to be in progress when at least one of the conditions (A1), (A2), and (A3) is satisfied, a steering operation for avoiding a collision between the obstacle 110 and the vehicle 100 is less likely to be determined to be in progress even if such a steering operation has not been started. This limits unnecessary intervention by the turn assist control.

The above-described embodiment may be modified as follows. The above-described embodiment and the following modifications can be combined as long as the combined modifications remain technically consistent with each other.

In the above-described embodiment, a wheel that satisfies the expression 2 is determined to be receiving a lateral force greater than or equal to the limit value. However, the present disclosure is not limited to this. For example, when a yaw rate that is calculated based on the steering angle STr is used as a yaw rate target value, the vehicle 100 is likely to slide sideways if the difference between the yaw rate target value and the yaw rate γ is greater than or equal to a threshold. Thus, the wheels 10F, 10R of the vehicle 100 may be determined to include a wheel receiving a lateral force greater than or equal to the limit value when the difference between the yaw rate target value and the yaw rate γ is greater than or equal to the threshold.

The braking/driving force adjusting process does not necessarily need to adjust the difference in braking force between the right rear wheel 10R and the left rear wheel 10R if the difference in braking force between the right front wheel 10F and the left front wheel 10F is adjusted.

The braking/driving force adjusting process does not necessarily need to adjust the difference in braking force between the right front wheel 10F and the left front wheel 10F if the difference in braking force between the right rear wheel 10R and the left rear wheel 10R is adjusted.

When the braking/driving force adjusting process adjusts the braking force applied to the wheels 10F, 10R, the braking force applied to the entire vehicle may be increased, so that the vehicle 100 is decelerated. Thus, during the execution of the braking/driving force adjusting process, the driving device 50 may be activated to increase the driving force of the vehicle 100 in order to compensate for the deceleration of the vehicle 100 that accompanies the execution of the braking/driving force adjusting process. This limits the deceleration of the vehicle 100 that accompanies the execution of the braking/driving force adjusting process.

In a case in which the driving device 50 has a function of adjusting the difference in the driving force applied to a right wheel and the driving force applied to a left wheel, the braking/driving force adjusting process may adjust the difference between the driving force applied to the right wheel and the driving force applied to the left wheel, so as to increase the yaw moment of the vehicle 100.

The braking/driving force adjusting process does not necessarily need to be executed during the turn assist control.

It may be determined that a steering operation is in progress when the condition (A1) is satisfied regardless whether the conditions (A2) and (A3) are satisfied.

It may be determined that a steering operation is in progress when the condition (A2) is satisfied regardless whether the conditions (A1) and (A3) are satisfied.

It may be determined that a steering operation is in progress when the condition (A3) is satisfied regardless whether the conditions (A1) and (A2) are satisfied.

The turn assist device may have any one of the above-described configurations (a) to (c).

The turn assist device may include the integrated controller 80 and the rear wheel steering control unit 31. The turn assist device may further include the braking control unit 41 and the driving control unit 51.

The actual value of the lateral acceleration is not limited to the detection value of the lateral acceleration sensor 63, but may be a value calculated using the front wheel steered angle δf, the rear wheel steered angle δr, the vertical load W, the friction coefficient μ of the road surface, the vehicle speed Vxe, and the like. That is, the actual value of the lateral acceleration refers to both the detection value and the calculated value of the lateral acceleration.

The above-described vehicle may include only one front wheel 10F.

The above-described vehicle may include only one rear wheel 10R.

In this specification, “at least one of A and B” should be understood to mean “only A, only B, or both A and B.”

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A turn assist device for a vehicle, the vehicle including wheels including a front wheel and a rear wheel, a rear wheel steering device that adjusts a steered angle of the rear wheel, and a steering wheel, the front wheel being configured to be steered in accordance with a steering operation of the steering wheel, the turn assist device comprising processing circuitry configured to execute:
a time obtaining process that obtains collision prediction time, the collision prediction time being a predicted value of an amount of time before the vehicle collides with an obstacle in a case in which the vehicle is approaching the obstacle;
a target value obtaining process that obtains a lateral acceleration target value based on a vehicle speed and a steering angle of the steering wheel, the lateral acceleration target value being a target value of a lateral acceleration of the vehicle; and
a turn assist process in a case in which the steering operation of the steering wheel is in progress in a situation in which the collision prediction time is shorter than or equal to determination prediction time, the turn assist process assisting turning of the vehicle by outputting a command for steering the rear wheel to the rear wheel steering device, wherein
the turn assist process includes:
an in-phase process that outputs, to the rear wheel steering device, a command for steering the rear wheel in a same direction as a steering direction of the front wheel, and
a counter-phase process that outputs, to the rear wheel steering device, a command for steering the rear wheel in a direction opposite to the steering direction of the front wheel when a difference between an actual value of the lateral acceleration of the vehicle and the lateral acceleration target value exceeds a difference determination value during execution of the in-phase process.

2. The turn assist device for the vehicle according to claim 1, wherein the processing circuitry is configured to,
in a situation in which the collision prediction time is shorter than or equal to the determination prediction time,
start the turn assist process if at least one of following conditions is satisfied: a condition that a steering torque applied to the steering wheel is greater than or equal to a steering torque determination value; a condition that a steering speed of the steering wheel is greater than or equal to a steering speed determination value; and a condition that the steering angle is greater than or equal to a steering angle determination value.

3. The turn assist device for the vehicle according to claim 1, wherein
the processing circuitry is configured to determine whether the wheels include a wheel receiving a lateral force greater than or equal to a limit value, and
the turn assist process includes increasing a yaw moment of the vehicle by adjusting at least one of a braking force and a driving force applied to the wheels, in a case in which the wheels are not determined to include a wheel receiving a lateral force greater than or equal to the limit value.

4. A non-transitory computer readable medium storing a turn assist program executed by a controller for a vehicle, the vehicle including wheels including a front wheel and a rear wheel, a rear wheel steering device that adjusts a steered angle of the rear wheel, and a steering wheel, the front wheel being configured to be steered in accordance with a steering operation of the steering wheel, the turn assist program being configured to cause the controller to execute:
a time obtaining process that obtains collision prediction time, the collision prediction time being a predicted value of an amount of time before the vehicle collides with an obstacle in a case in which the vehicle is approaching the obstacle;
a turn assist process in a case in which the steering operation of the steering wheel is in progress in a situation in which the collision prediction time is shorter than or equal to determination prediction time, the turn assist process assisting turning of the vehicle by outputting a command for steering the rear wheel to the rear wheel steering device; and
a target value obtaining process that obtains a lateral acceleration target value based on a vehicle speed and a steering angle of the steering wheel, the lateral acceleration target value being a target value of a lateral acceleration of the vehicle, wherein
the turn assist process includes:
an in-phase process that outputs, to the rear wheel steering device, a command for steering the rear wheel in a same direction as a steering direction of the front wheel, and
a counter-phase process that outputs, to the rear wheel steering device, a command for steering the rear wheel in a direction opposite to the steering direction of the front wheel when a difference between an actual value of the lateral acceleration of the vehicle and the lateral acceleration target value exceeds a difference determination value during execution of the in-phase process.

5. A turn assist method for a vehicle, the vehicle including wheels including a front wheel and a rear wheel, a rear wheel steering device that adjusts a steered angle of the rear wheel, and a steering wheel, the front wheel being configured to be steered in accordance with a steering operation of the steering wheel, the turn assist method comprising:
obtaining collision prediction time, the collision prediction time being a predicted value of an amount of time before the vehicle collides with an obstacle in a case in which the vehicle is approaching the obstacle;
obtaining a lateral acceleration target value based on a vehicle speed and a steering angle of the steering wheel, the lateral acceleration target value being a target value of a lateral acceleration of the vehicle; and
executing a turn assist process in a case in which the steering operation of the steering wheel is in progress in a situation in which the collision prediction time is shorter than or equal to determination prediction time, the turn assist process assisting turning of the vehicle by outputting a command for steering the rear wheel to the rear wheel steering device, wherein
the turn assist process includes:
an in-phase process that outputs, to the rear wheel steering device, a command for steering the rear wheel in a same direction as a steering direction of the front wheel, and
a counter-phase process that outputs, to the rear wheel steering device, a command for steering the rear wheel in a direction opposite to the steering direction of the front wheel when a difference between an actual value of the lateral acceleration of the vehicle and the lateral acceleration target value exceeds a difference determination value during execution of the in-phase process.
